(19) United States
(12) Patent Application Publication
(10) Pub. No.: US 2023/0053944 A1
(43) Pub. Date: Feb. 23, 2023

(54) METHOD OF PREDICTIVELY MAINTAINING EQUIPMENT BY MEANS OF DISTRIBUTION MAP

(71) Applicant: ITS CO., LTD., Ulsan (KR)

(72) Inventor: Young Kyu Lee, Ulsan (KR)

(73) Assignee: ITS CO., LTD., Ulsan (KR)

(21) Appl. No.: 17/769,649

(22) PCT Filed: Oct. 14, 2020
(86) PCT No.: PCT/KR2020/013982

§ 371 Date: Apr. 15, 2022

(30) Foreign Application Priority Data
Oct. 15, 2019 (KR) 10-2019-0128094

(51) Int. Cl. G05B 23/02

(52) U.S. Cl. CPC G05B 23/0283; G05B 23/0221; G05B 23/0235

(57) ABSTRACT

Disclosed is a method of predictively maintaining equipment by means of a distribution map. The method can: extract a peak value based on a change in the amount of energy required for the equipment to perform a working process in a normal state; generate the distribution map based on the extracted peak value; and predictively detect, in advance, abnormalities of the equipment on the basis of a change in a distribution probability of a detection section having a low distribution probability and a somewhat high risk in the generated distribution map, so as to induce maintenance and replacement of the equipment to be carried out in a timely manner. Thus, enormous financial losses due to equipment failure may be prevented.

### CROSS-REFERENCE TO RELATED APPLICATIONS

This application is a U.S. national stage of International Patent Application No. PCT/KR2020/013982, filed Oct. 14, 2020, which claims priority to and the benefit of Korean Patent Application 10-2019-0128094, filed Oct. 15, 2019, the entirety of each of which is incorporated herein by reference.

### FIELD

The present disclosure relates to a method of predictively maintaining equipment by means of a distribution map, and more specifically to a method of predictively maintaining equipment by means of a distribution map. The method can: extract a peak value based on a change in the amount of energy required for the equipment to perform a working process in a normal state; generate the distribution map based on the extracted peak value; and predictively detect, in advance, abnormalities of the equipment based on a change in a distribution probability of a detection section having a low distribution probability and a somewhat high risk in the generated distribution map, so as to induce maintenance and replacement of the equipment to be carried out in a timely manner. By the method, enormous financial losses due to equipment failure may be prevented.

### BACKGROUND

The statements in this section merely provide background information related to the present disclosure and may not constitute prior art.

In general, in the case of various equipment used for an automated process of a facility, a stable operation is very important.

For example, hundreds of equipment are installed in the facilities of a large-scale production plant to continuously produce products while interlocking with each other. If any one of a plurality of equipment has a malfunction, an enormous situation may occur in which an operation of the facility is stopped as a whole.

At this time, due to the occurrence of down time due to the malfunction of the equipment, a huge loss is caused by not only the repair cost of the equipment, but also operating costs wasted while the facility is stopped and business is also affected.

According to recent data from the Ministry of Employment and Labor and the Korea Occupational Safety and Management Agency, casualties caused by the annual industrial safety accidents were collected at a total of 100,000, and a loss of 18 trillion won annually occurs when converting the casualties into costs.

As a method for avoiding such unexpected downtime costs, it is urgent to introduce a predictive maintenance system. There are efforts to improve the problem under the name of predictive maintenance, but it is necessary to develop higher predictive maintenance methods for more efficient predictive maintenance.

### SUMMARY

The present disclosure provides a method of predictively maintaining equipment by means of a distribution map. The method may extract a peak value based on a change in the amount of energy required for the equipment to perform a working process in a normal state; generate the distribution map based on the extracted peak value; and predictively detect, in advance, abnormalities of the equipment based on a change in a distribution probability of a detection section having a low distribution probability and a somewhat high risk in the generated distribution map, so as to induce maintenance and replacement of the equipment to be carried out in a timely manner. By such a method, enormous financial losses due to equipment failure may be prevented.

Further, the present disclosure also provides a method of predictively maintaining equipment by means of a distribution map. The method presents various detection conditions to efficiently search for an abnormal symptom, which occurs in the equipment. The method also detects the equipment in an abnormal state when the detection condition is satisfied to precisely and effectively detect the abnormal symptom, which occurs in the equipment, and secure excellent reliability for a detection result.

In order to achieve the object, a method of predictively maintaining equipment by means of a distribution map includes an information collecting step (S10) of measuring information in which the amount of energy required for the equipment to perform one working process in a normal driving state is changed according to the flow of time, and setting and collecting a value having a largest amount of energy as a peak value in the change information of the measured amount of energy. The method also includes a first distribution map generating step (S20) of collecting all peak values for respective working processes repeatedly performed in the equipment based on the information collected in the information collecting step (S10), generating a first distribution map based on the collected peak value, and repeatedly generating the first distribution map for an operation repeatedly performed in the equipment at a set peak unit time interval. The method also includes a first section setting step (S30) of arbitrarily setting a section in which a distribution probability of the peak value is high as a peak average section in the first distribution map and setting any one section or two or more sections selected among sections other than the set peak average section as a peak detection section. The method also includes a threshold value setting step (S40) of setting a peak threshold value for the distribution probability of the peak detection section. The method also includes a detecting step (S50) of warning and inducing an inspection and management of the equipment when the distribution probability of the peak detection section exceeds the peak threshold value in a real-time distribution map generated based on the peak value for the working process repeatedly performed within the peak unit time in a real-time driving state of the equipment. The peak unit time is set as a time including two or more working processes.

Further, the method further includes a second distribution map generating step (S60) in which all of the distribution probabilities for the peak detection section of the first distribution map repeatedly collected through the information collecting step (S10), the first distribution map generating step (S20), and the first section setting step (S30) are collected. A second distribution map for the collected distribution probability values of the peak detection section is generated, and the second distribution map for the peak detection section of the first distribution map repeatedly generated at the set distribution unit time interval is repeatedly generated. The method further includes a second section setting step (S70). In this step, a section in which the distribution probability of the distribution probability value of the peak detection section is high is arbitrarily set as a distribution average section in the second distribution map. Any one section or two or more sections selected among sections other than the set distribution average section are as a distribution detection section. In the threshold value setting step (S40), a threshold value for the distribution probability of the distribution detection section is set. In the detecting step (S50), when the distribution probability of the distribution detection section of the second distribution map of the distribution probability value for the peak detection section of the first distribution map repeatedly generated within the distribution unit time in the real-time driving state of the equipment exceeds the distribution threshold value, the inspection and management of the equipment are induced by warning, and the distribution unit time is set as a time including two or more first distribution maps.

Further, the method further includes a slope information collecting step (S80). In this step, the distribution probability values for the peak detection section of the first distribution map repeatedly collected in the information collecting step (S10), the first distribution map generating step (S20), and the first section setting step (S30) are arranged according to the flow of the time. The arranged distribution probability values of the peak detection section are connected to each other by straight lines, and then peak slope information is collected through slopes of the straight lines. In the second distribution map generating step (S60), the distribution probability values for the distribution detection section of the second distribution map collected repeatedly are arranged according to the flow of the time. The arranged distribution probability values of the distribution detection section are connected to each other by the straight line, and then distribution slope information is collected through the straight-line slope. In the threshold value setting step (S40), each of a threshold value of a peak slope for the peak detection section and a threshold value of a distribution slope for the distribution detection section is set. In the detecting step (S50), when the distribution probability values for the peak detection section of the first distribution map repeatedly collected in the real-time driving state of the equipment are arranged according to the flow of the time, the arranged distribution probability values of the peak detection section are connected to each other by the straight line to measure the peak slope value, and the measured peak slope value exceeds the threshold value of the peak slope. Alternatively, when the distribution probability values for the distribution detection section of the second distribution map repeatedly collected in the real-time driving state of the equipment are arranged according to the flow of the time, the arranged distribution probability values of the distribution detection section are connected to each other by the straight line to measure the distribution slope value, and the measured distribution slope value exceeds the threshold value of the distribution slope, the inspection and management of the equipment are induced by warning.

Further, in the threshold value setting step (S40), each of the threshold value of the peak average slope for the peak detection section and the threshold value of the distribution average slope for the distribution detection section is further set. In the detecting step (S50), when a peak average detection section including the peak slope value for the peak detection section twice or more in the real-time driving state of the equipment is set, the respective peak slope values included in the set peak average detection section are collected, and the averaged peak average slope value exceeds the threshold value of the peak average slope. Alternatively, when a distribution average detection section including the distribution slope value for the distribution detection section twice or more in the real-time driving state of the equipment is set, the respective distribution slope values included in the set distribution average detection section are collected, and the averaged distribution average slope value exceeds the threshold value of the distribution average slope, the inspection and management of the equipment are induced by warning.

By a method of predictively maintaining equipment by means of a distribution map according to the present disclosure, there is an effect that a peak value is extracted based on a change in the amount of energy required for the equipment to perform a working process in a normal state; the distribution map is generated based on the extracted peak value; and abnormalities of the equipment are predictively detected in advance based on a change in a distribution probability of a detection section having a low distribution probability and a somewhat high risk in the generated distribution map, so as to induce maintenance and replacement of the equipment to be carried out in a timely manner. Thus, enormous financial losses due to equipment failure may be prevented.

Further, there is an effect that various detection conditions are presented to efficiently search for an abnormal symptom, which occurs in the equipment, and the equipment in an abnormal state is detected when the detection condition is satisfied. Thus, the abnormal symptom, which occurs in the equipment, may be precisely and effectively detected, and excellent reliability for a detection result may be secured.

### DRAWINGS

In order that the disclosure may be well understood, there will now be described various forms thereof, given by way of example, reference being made to the accompanying drawings, in which:

FIG. 1 is a block diagram of a method of predictively maintaining equipment by means of a distribution map according to an embodiment of the present disclosure.

FIGS. 2-14 are diagrams for describing the method of predictively maintaining equipment by means of a distribution map illustrated in FIG. 1.

### DESCRIPTION OF MAIN REFERENCE NUMERALS OF DRAWINGS

S10: Information collecting step
S20: First distribution map generating step
S30: First section setting step
S40: Threshold value setting step
S50: Detecting step
S60: Second distribution map generating step
S70: Second section setting step
S80: Slope information collecting step
100: Method of predictively maintaining equipment by means of distribution map

### DETAILED DESCRIPTION

A method of predictively maintaining equipment by means of a distribution map includes an information collecting step (S10) of measuring information in which the amount of energy required for the equipment to perform one working process in a normal driving state is changed according to the flow of time, and setting and collecting a value having a largest amount of energy as a peak value in the change information of the measured amount of energy. The method also includes a first distribution map generating step (S20) of collecting all peak values for respective working processes repeatedly performed in the equipment based on the information collected in the information collecting step (S10), and generating a first distribution map based on the collected peak value, and repeatedly generating the first distribution map for an operation repeatedly performed in the equipment at a set peak unit time interval. The method also includes a first section setting step (S30) of arbitrarily setting a section in which a distribution probability of the peak value is high as a peak average section in the first distribution map, and setting any one section or two or more sections selected among sections other than the set peak average section as a peak detection section. The method also includes a threshold value setting step (S40) of setting a peak threshold value for the distribution probability of the peak detection section. The method also includes a detecting step (S50) of warning and inducing an inspection and management of the equipment when the distribution probability of the peak detection section exceeds the peak threshold value in a real-time first distribution map generated based on the peak value for the working process repeatedly performed within the peak unit time in a real-time driving state of the equipment. The peak unit time is set as a time including two or more working processes.

A method of predictively maintaining equipment by means of a distribution map according to an embodiment of the present disclosure is described in detail with reference to the accompanying drawings. The detailed description of publicly-known function and configuration that may make the gist of the present disclosure unnecessarily ambiguous have been omitted.

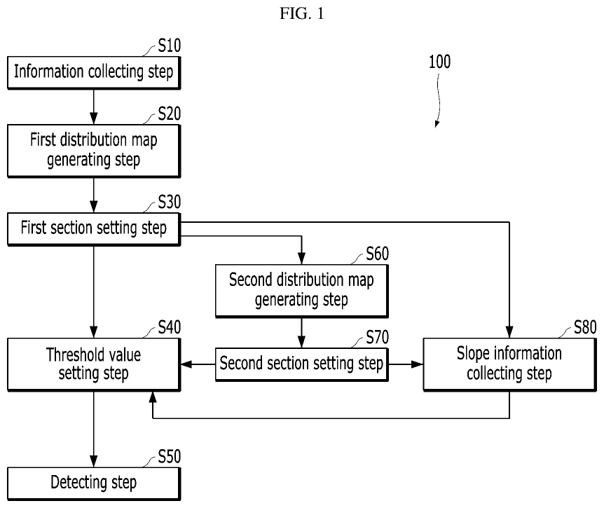

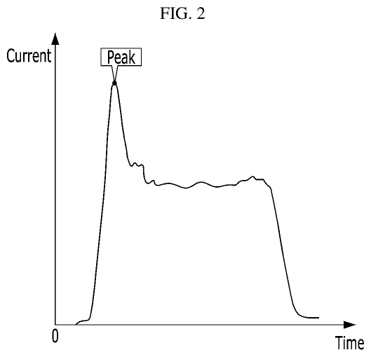

FIGS. 1-14 illustrate a method of predictively maintaining equipment by means of a distribution map according to an embodiment of the present disclosure. FIG. 1 is a block diagram of a method of predictively maintaining equipment by means of a distribution map according to an embodiment of the present disclosure. FIGS. 2-14 are diagrams for describing the method of predictively maintaining equipment by means of a distribution map illustrated in FIG. 1.

As illustrated in the figure, the method 100 of predictively maintaining equipment by means of a distribution map according to an embodiment of the present disclosure includes an information collecting step (S10), a first distribution map generating step (S20), a first section setting step (S30), a threshold value setting step (S40), and a detecting step (S50).

The information collecting step (S10) is a step of measuring information in which the amount of energy required for the equipment to perform one working process in a normal driving state is changed according to the flow of time, and setting and collecting a value having a largest amount of energy as a peak value in the change information of the measured amount of energy.

In general, the equipment that is installed in large facilities and operates organically performs a specific working process repeatedly, and in this case, as the energy required for the equipment, current (power), a frequency of supplied power, vibration, noise, etc., generated from the equipment, etc., may be selectively used.

For example, when as the energy required for equipment such as a perforator that performs a working process of perforating a hole in a material to perform the working process, current supplied to the equipment is represented according to the flow of the time, a waveform illustrated in FIG. 2 is illustrated.

In this case, a value of current which is the largest is set as a peak value, and the peak value is collected in the first information collecting step (S10).

The first distribution map generating step (S20) is a step of collecting all peak values for respective working processes repeatedly performed in the equipment based on the information collected in the information collecting step (S10), generating a first distribution map based on the collected peak value, and repeatedly generating the first distribution map for an operation repeatedly performed in the equipment at a set peak unit time interval.

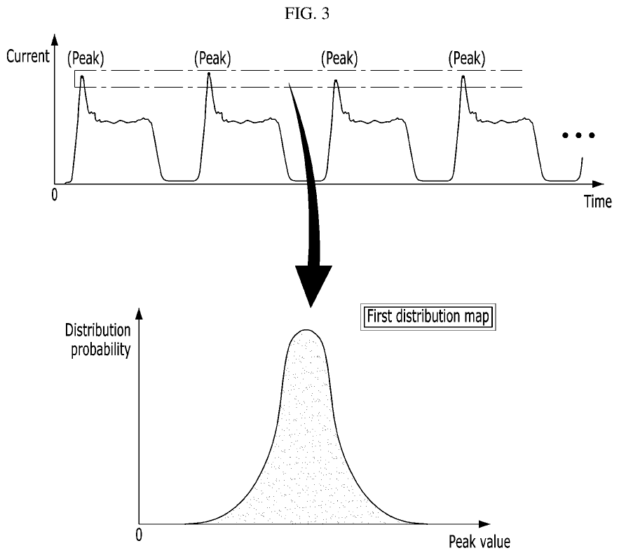

In other words, when the equipment repeatedly performs the working process, the peak value may be repeatedly collected as illustrated in FIG. 3, and the first distribution map illustrated in FIG. 3 may be generated based on multiple collected peak values.

Here, the peak unit time as a time set to include two or more peak values may be set to units including at least several seconds to at most a day, a month, a year, etc., by considering a driving condition, a surrounding environment, etc., of the equipment.

The first section setting step (S30) is a step of arbitrarily setting a section in which a distribution probability of the peak value is high as a peak average section in the first distribution map, and setting any one section or two or more sections selected among sections other than the set peak average section as a peak detection section.

Here, a peak value in which the distribution probability is high in the normal state of the equipment may be regarded as a value in which the state of the equipment is somewhat stable, and a peak value in which the distribution probability is low, i.e., a value in which the peak value is formed to be too large or on the contrary, the peak value is formed to be too small may be regarded as a value in which the state of the equipment is somewhat unstable.

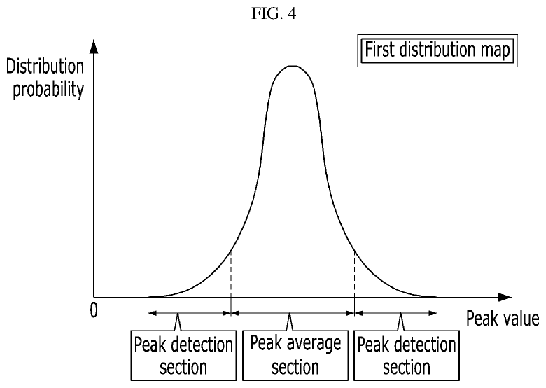

Accordingly, as illustrated in FIG. 4, when the first distribution map is partitioned into the peak average section and the peak detection section, the peak average section is an area where the peak value in which the equipment is in a stable state is distributed and the peak detection section is an area where the peak value in which the equipment is in a somewhat unstable state is distributed.

Here, as the peak detection section, all sections other than the peak average section, i.e., both sections of the peak average section are selected as the peak detection section, but only the selected section is not selected as the peak detection section.

The threshold value setting step (S40) is a step of setting a peak threshold value for the distribution probability of the peak detection section.

Here, the peak threshold value as a value for warning when the distribution probability of the peak detection section partitioned in the first distribution map is abnormally increased may be set to values having various sizes by considering the type of equipment, a use environment, a life-span, a size (distribution probability) of the peak detection section, and the like. The peak threshold value is divided and set into two or more threshold values, e.g., a warning threshold value, a risk threshold value, etc., to variously form levels for the warning. Thus, the abnormal symptom of the equipment may be warned.

The detecting step (S50) is a step of warning and inducing an inspection and management of the equipment when the distribution probability of the peak detection section exceeds the peak threshold value in a real-time first distribution map generated based on the peak value for the working process repeatedly performed within the peak unit time in a real-time driving state of the equipment.

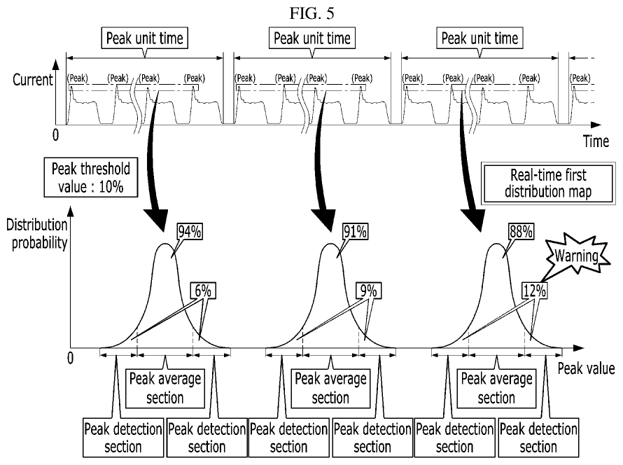

In other words, the real-time first distribution map is generated based on the peak value for the working process within the peak unit time in the real-time driving state of the equipment as illustrated in FIG. 5. By a scheme in which the real-time first distribution map is repeatedly generated at the repeated peak unit time interval, and the distribution probability for the peak detection section of the real-time first distribution map generated in this case and the peak threshold value set in the threshold value setting step (S40) are compared and when the distribution probability of the peak detection section of the real-time first distribution map does not exceed the peak threshold value, it is detected that the equipment is in the very stable state. When the distribution probability exceeds the peak threshold value, it is detected and warned that the equipment is in the somewhat unstable state. The abnormal symptom of the equipment is detected before the failure of the equipment occurs to induce the inspection and management of the equipment. Thus, prevention of economic losses, which may be generated as overall actuation of facilities is stopped due to a sudden failure of the equipment, may be induced.

For example, in FIG. 5, the peak threshold value is set to 10%, and the distribution probability of the peak detection section of the real-time first distribution map of the equipment is compared with the set peak threshold value to compare and detect the abnormal symptom of the equipment.

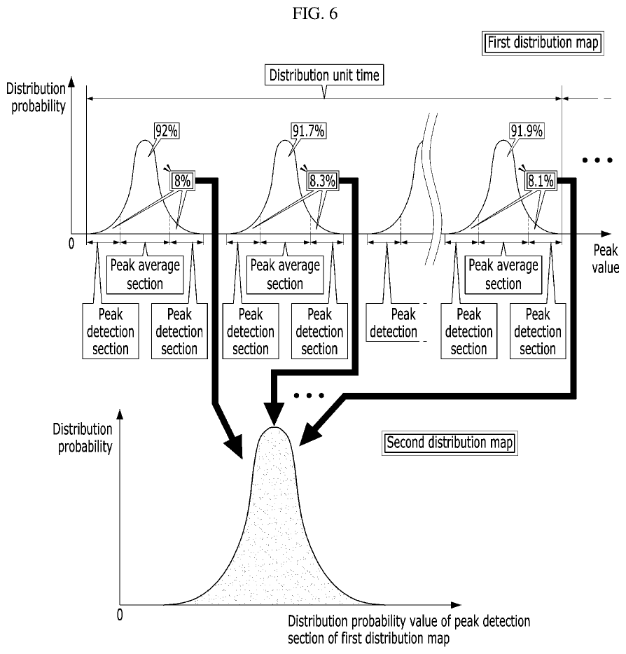

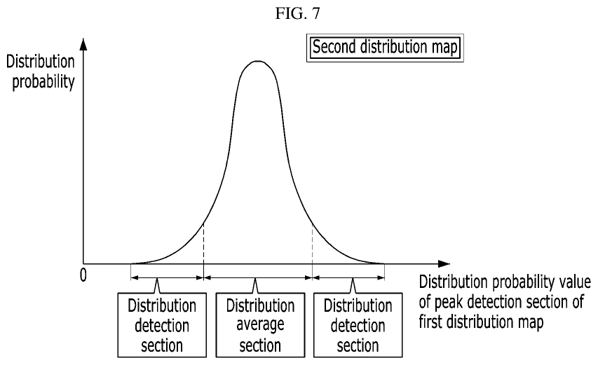

Meanwhile, the method further includes a second distribution map generating step (S60). As illustrated in FIG. 6, all of the distribution probabilities for the peak detection section of the first distribution map repeatedly collected through the information collecting step (S10), the first distribution map generating step (S20), and the first section setting step (S30) are collected and a second distribution map for the collected distribution probability values of the peak detection section is generated, and the second distribution map for the peak detection section of the first distribution map repeatedly generated at the set distribution unit time interval is repeatedly generated. The method further includes a second section setting step (S70). As illustrated in FIG. 7, a section in which the distribution probability of the distribution probability value of the peak detection section is high is arbitrarily set as a distribution average section in the second distribution map, and any one section or two or more sections selected among sections other than the set distribution average section are as a distribution detection section.

Here, the distribution unit time as a time set to include two or more distribution probability values of the peak detection section of the first distribution map may be, of course, set to units such as at least several seconds to at most a day, a month, a year, etc., by considering a driving condition of the equipment, a surrounding environment, etc., and the second distribution map is generated by a value in which the state of the equipment corresponding to the peak detection section is somewhat unstable in the first distribution map. In this case, the distribution detection section of the second distribution map may be regarded as a section in which values in which the state of the equipment is further unstable are distributed.

Then, the distribution threshold value for the distribution probability of the distribution detection section is set in the threshold value setting step (S40). In this case, the distribution threshold value as a value for warning when the distribution probability of the distribution detection section partitioned in the second distribution map is increased may be set to values having various sizes by considering the type of equipment, the use environment, the life-span, a size (distribution probability) of the distribution detection section, and the like. The distribution threshold value is divided and set into two or more threshold values, e.g., the warning threshold value, the risk threshold value, etc., to variously form levels for the warning. Thus, the abnormal symptom of the equipment may be warned.

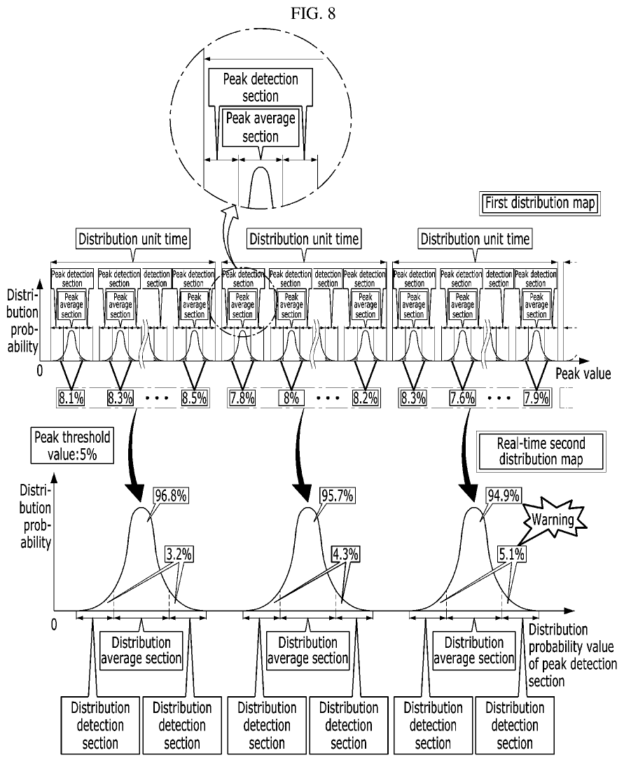

Then, as illustrated in FIG. 8, in the detecting step (S50), when the distribution probability of the distribution detection section of the second distribution map of the distribution probability value for the peak detection section of the first distribution map repeatedly generated within the distribution unit time in the real-time driving state of the equipment exceeds the distribution threshold value, the inspection and management of the equipment are induced by warning.

For example, in FIG. 8, the distribution threshold value is set to 5%, and the distribution probability of the distribution detection section of the real-time second distribution map of the equipment is compared with the set distribution threshold value to compare and detect the abnormal symptom of the equipment.

In other words, since the method 100 of predictively maintaining equipment by means of a distribution map according to the present disclosure may more accurately and precisely detect and predict the abnormal symptom of the equipment through the peak threshold value for the distribution probability of the peak detection section and the distribution threshold value for the distribution detection section. Thus, excellent reliability for the warning of the equipment may be secured.

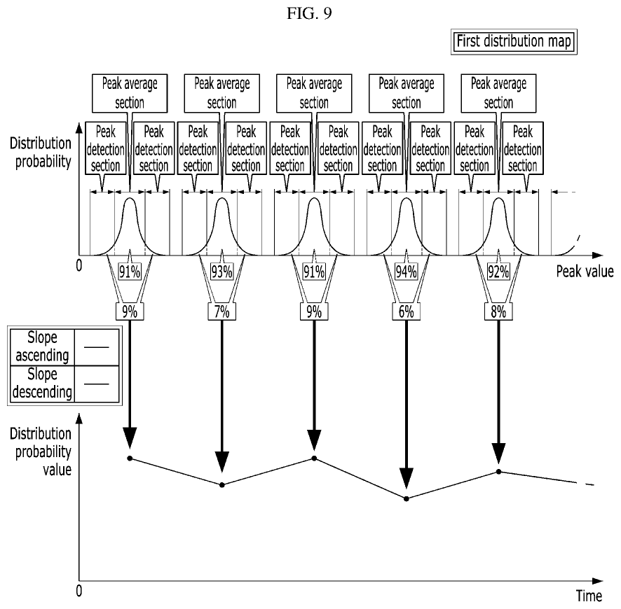

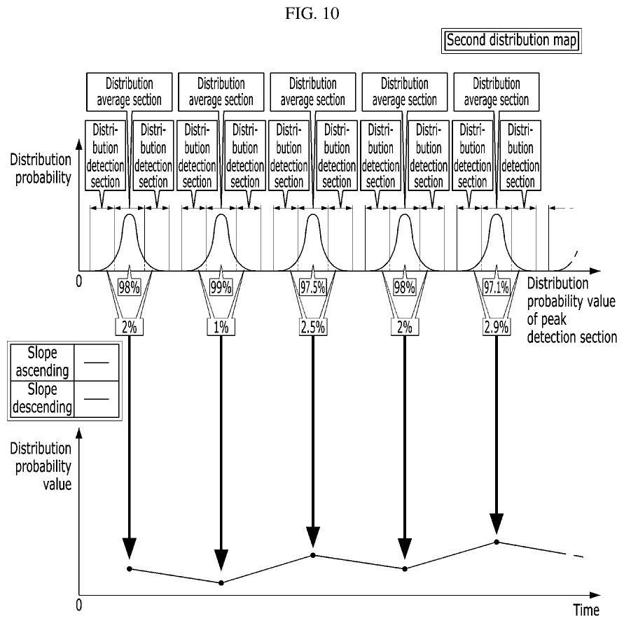

Meanwhile, as illustrated in FIG. 9, in the slope information collecting step (S80), the distribution probability values for the peak detection section of the first distribution map repeatedly collected in the information collecting step (S10), the first distribution map generating step (S20), and the first section setting step (S30) are arranged according to the flow of the time, the arranged distribution probability values of the peak detection section are connected to each other by straight lines, and then peak slope information is collected through slopes of the straight lines. As illustrated in FIG. 10, in the second distribution map generating step (S60), the distribution probability values for the distribution detection section of the second distribution map collected repeatedly are arranged according to the flow of the time, the arranged distribution probability values of the distribution detection section are connected to each other by the straight line, and then distribution slope information is collected through the straight-line slope.

Here, the slope value may be divided into an ascending slope value (positive number) in which a slope ascends and a descending slope value (negative number) in which the slope descends, but all slope values are digitized and collected to absolute values.

Then, in the threshold value setting step (S40), each of a threshold value of a peak slope for the peak detection section and a threshold value of a distribution slope for the distribution detection section is set.

Here, the peak slope threshold value is a value for warning when the slope value of the straight line connecting the distribution probability value of the peak detection section and the distribution probability value of the other peak detection section partitioned in the first distribution map is abnormally increased. The distribution slope threshold value is a value for warning when the slope value of the straight line connecting the distribution probability value of the distribution detection section and the distribution probability value of the other distribution detection section partitioned in the second distribution map is abnormally increased.

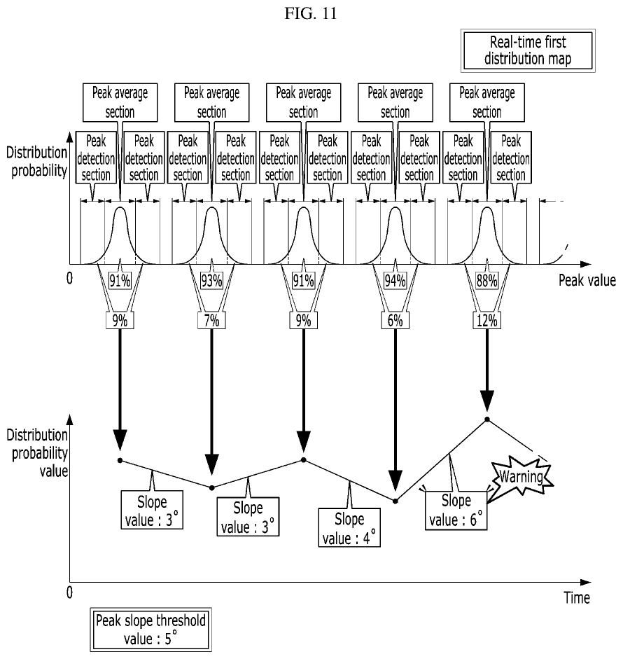

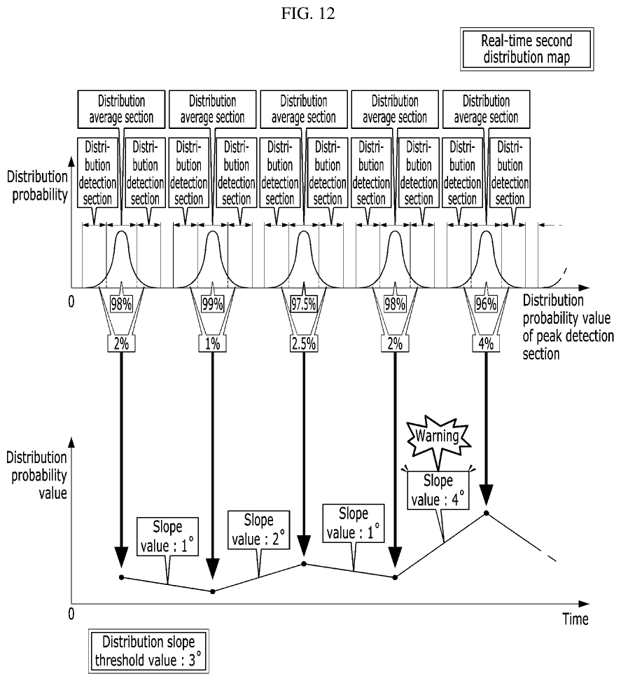

Then, as illustrated in FIG. 11, in the detecting step (S50), when the distribution probability values for the peak detection section of the first distribution map repeatedly collected in the real-time driving state of the equipment are arranged according to the flow of the time, the arranged distribution probability values of the peak detection section are connected to each other by the straight line to measure the peak slope value, and the measured peak slope value exceeds the threshold value of the peak slope. Alternatively, as illustrated in FIG. 12, when the distribution probability values for the distribution detection section of the second distribution map repeatedly collected in the real-time driving state of the equipment are arranged according to the flow of the time, the arranged distribution probability values of the distribution detection section are connected to each other by the straight line to measure the distribution slope value, and the measured distribution slope value exceeds the threshold value of the distribution slope, the inspection and management of the equipment are induced by warning.

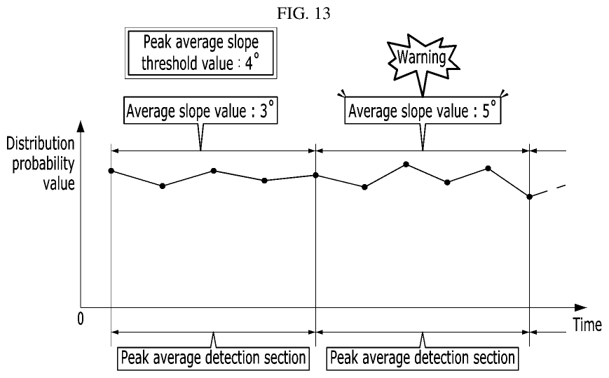

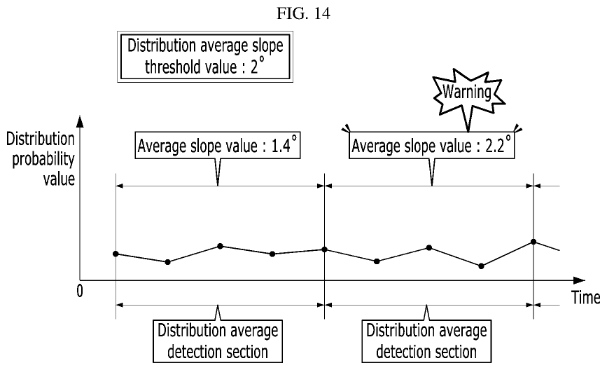

Further, in the threshold value setting step (S40), each of the threshold value of the peak average slope for the peak detection section and the threshold value of the distribution average slope for the distribution detection section is further set. As illustrated in FIG. 13, in the detecting step (S50), when a peak average detection section including the peak slope value for the peak detection section twice or more in the real-time driving state of the equipment is set, the respective peak slope values included in the set peak average detection section are collected, and the averaged peak average slope value exceeds the threshold value of the peak average slope. Alternatively, as illustrated in FIG. 14, when a distribution average detection section including the distribution slope value for the distribution detection section twice or more in the real-time driving state of the equipment is set, the respective distribution slope values included in the set distribution average detection section are collected, and the averaged distribution average slope value exceeds the threshold value of the distribution average slope, the inspection and management of the equipment are induced by warning.

The method 100 of predictively maintaining equipment by means of a distribution map according to the present disclosure, which predicts the abnormal symptom of the equipment by such a process, has an effect that a peak value is extracted based on a change in the amount of energy required for the equipment to perform a working process in a normal state; the distribution map is generated based on the extracted peak value; and abnormalities of the equipment are predictively detected in advance based on a change in a distribution probability of a detection section having a low distribution probability and a somewhat high risk in the generated distribution map, so as to induce maintenance and replacement of the equipment to be carried out in a timely manner. Thus, enormous financial losses due to equipment failure may be prevented.

Further, there is an effect that various detection conditions are presented to efficiently search for an abnormal symptom, which occurs in the equipment, and the equipment in an abnormal state is detected when the detection condition is satisfied. Thus, the abnormal symptom, which occurs in the equipment, may be precisely and effectively detected, and excellent reliability for a detection result may be secured.

It is described that the method 100 of predictively maintaining equipment by means of a distribution map according to the present disclosure detects the abnormal symptom of one equipment performing the working process through the distribution map. The method 100 may detect the abnormal symptom of the equipment by individually generating the distribution map for each equipment when multiple equipment are used to perform the working process or jointly detect the abnormal symptoms of all equipment performing the working process by adding and combining the distribution maps of the respective equipment, of course.

The present disclosure has been described with reference to the embodiment illustrated in the accompanying drawings and is just exemplary and is not limited to the above-described embodiments. It should be appreciated by those having ordinary skill in the art that various modifications and embodiments equivalent thereto can be made therefrom. In addition, modifications by those having ordinary skill in the art can be made without departing from the scope of the present disclosure. Therefore, the scope of the claims in the present disclosure should not be defined within the scope of the detailed description but should be defined by the following claims and the technical spirit thereof.

1. A method of predictively maintaining equipment by means of a distribution map, the method comprising:
an information collecting step of measuring information in which an amount of energy required for equipment to perform one working process in a normal driving state is changed according to the flow of time, and setting and collecting a value having a largest amount of energy as a peak value in the change information of the measured amount of energy;
a first distribution map generating step of collecting all peak values for respective working processes repeatedly performed in the equipment based on the information collected in the information collecting step, and generating a first distribution map based on the collected peak value, and repeatedly generating the first distribution map for an operation repeatedly performed in the equipment at a set peak unit time interval;
a first section setting step of arbitrarily setting a section in which a distribution probability of the peak value is high as a peak average section in the first distribution map, and setting any one section or two or more sections selected among sections other than the set peak average section as a peak detection section;
a threshold value setting step of setting a peak threshold value for the distribution probability of the peak detection section; and
a detecting step of warning and inducing an inspection and management of the equipment when the distribution probability of the peak detection section exceeds the peak threshold value in a real-time first distribution map generated based on the peak value for the working process repeatedly performed within the peak unit time in a real-time driving state of the equipment,
wherein the peak unit time is set as a time including two or more working processes,
wherein the method further comprises:
a second distribution map generating step in which all of the distribution probabilities for the peak detection section of the first distribution map repeatedly collected through the information collecting step, the first distribution map generating step, and the first section setting step are collected, and a second distribution map for the collected distribution probability values of the peak detection section is generated, and the second distribution map for the peak detection section of the first distribution map repeatedly generated at the set distribution unit time interval is repeatedly generated; and
a second section setting step in which a section in which the distribution probability of the distribution probability value of the peak detection section is high is arbitrarily set as a distribution average section in the second distribution map, and any one section or two or more sections selected among sections other than the set distribution average section are as a distribution detection section,
wherein in the threshold value setting step, a distribution threshold value for the distribution probability of the distribution detection section is set,
wherein in the detecting step, when the distribution probability of the distribution detection section of the second distribution map of the distribution probability value for the peak detection section of the first distribution map repeatedly generated within the distribution unit time in the real-time driving state of the equipment exceeds the distribution threshold value, the inspection and management of the equipment are induced by warning, and
wherein the distribution unit time is set as a time including two or more first distribution maps.

2. (canceled)

3. The method of predictively maintaining equipment by means of a distribution map of claim 1, further comprising:
a slope information collecting step in which the distribution probability values for the peak detection section of the first distribution map repeatedly collected in the information collecting step, the first distribution map generating step, and the first section setting step are arranged according to the flow of the time, the arranged distribution probability values of the peak detection section are connected to each other by straight lines, and then peak slope information is collected through slopes of the straight lines, and in the second distribution map generating step, the distribution probability values for the distribution detection section of the second distribution map collected repeatedly are arranged according to the flow of the time, the arranged distribution probability values of the distribution detection section are connected to each other by the straight line, and then distribution slope information is collected through the straight-line slope,
wherein in the threshold value setting step, each of a threshold value of a peak slope for the peak detection section and a threshold value of a distribution slope for the distribution detection section is set, in the detecting step, when the distribution probability values for the peak detection section of the first distribution map repeatedly collected in the real-time driving state of the equipment are arranged according to the flow of the time, the arranged distribution probability values of the peak detection section are connected to each other by the straight line to measure the peak slope value, and the measured peak slope value exceeds the threshold value of the peak slope, or when the distribution probability values for the distribution detection section of the second distribution map repeatedly collected in the real-time driving state of the equipment are arranged according to the flow of the time, the arranged distribution probability values of the distribution detection section are connected to each other by the straight line to measure the distribution slope value, and the measured distribution slope value exceeds the threshold value of the distribution slope, the inspection and management of the equipment are induced by warning.

4. The method of predictively maintaining equipment by means of a distribution map of claim 3, wherein in the threshold value setting step, each of a threshold value of a peak average slope for the peak detection section and a threshold value of a distribution average slope for the distribution detection section is further set, and
in the detecting step, when a peak average detection section including the peak slope value for the peak detection section twice or more in the real-time driving state of the equipment is set, the respective peak slope values included in the set peak average detection section are collected, and the averaged peak average slope value exceeds the threshold value of the peak average slope, or
when a distribution average detection section including the distribution slope value for the distribution detection section twice or more in the real-time driving state of the equipment is set, the respective distribution slope values included in the set distribution average detection section are collected, and the averaged distribution average slope value exceeds the threshold value of the distribution average slope, the inspection and management of the equipment are induced by warning.
